(19) United States
(12) Patent Application Publication
(10) Pub. No.: US 2006/0096750 A1
(43) Pub. Date: May 11, 2006

(54) Heat exchanger

(76) Inventor: Andries Meuzelaar, Poppel (Ravels) (BE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/515,524

(22) PCT Filed: May 30, 2003
(86) PCT No.: PCT/NL03/00406

§ 371 Date: Aug. 15, 2005

(30) Foreign Application Priority Data
May 29, 2002 (NL) 1020708

(51) Int. Cl. F28F 1/20; B23K 31/02

(52) U.S. Cl. 165/181; 165/907; 228/183

(57) ABSTRACT

The invention relates to a heat exchanger for motorized vehicles, comprising: at least one heat-conducting conduit for passage of a first medium, a covering of a thermally conducting porous structure connected to an external side of the conduit for passage of a second medium surrounding the conduit.

The invention relates to a heat exchanger for motorized vehicles, comprising: at least one heat-conducting conduit for passage of a first medium, a covering of a single thermally conducting porous structure connected to an external side of the conduit for passage of a second medium surrounding the conduit. The invention also relates to a motorized vehicle provided with such a heat-exchanger. The invention further relates to a method for applying a heat exchanger arranged in a motorized vehicle. In addition, the invention relates to methods for manufacturing such a heat exchanger.

In order to obtain the greatest possible heat transfer between the two media it is known to provide conduits on an outer side with fins around which the second medium flows (finned tube heat exchangers). Such heat exchangers are applied on large scale in industrial, automotive and domestic applications. Characteristic of these constructions is that the flow round these fins is laminar and that the dimensions of these fins and the mutual distance between the fins is many times greater than the thickness of the boundary layer in the second medium. It is known that the thickness of the boundary layer increases in the flow direction, wherein this flow becomes turbulent at a certain point (Reynolds number>300,000). For instance in the case of air at atmospheric pressure and gas flow speeds in the order of for instance 10 m/s, a distance is required herefor of about 0.5 metre. With a conduit for a first medium with a diameter and fin length shorter than this peripheral length, the flow is laminar, wherein the boundary layer in the second medium has a thickness in the order of 0.1 to 0.4 mm. It is known that the part of the second medium outside this boundary layer has no interaction with the conduit or the fins around which flow occurs, and thereby makes no contribution toward the heat transfer. This results in a fundamental limitation of the quantity of heat that can be transferred with a laminar flow around a conduit or along a fin.

In addition to the above stated heat exchangers, heat exchangers corresponding with the type stated in the preamble are also known in the prior art. Such a heat exchanger is described in the French patent FR 2 414 081 (UOP Inc.), wherein the porous structure is formed by a graphite foam. Such a porous three-dimensional structure can be understood as a cubic or hexagonal grid, wherein the nodes are mutually connected with thermally conducting wires. Owing to the large number of wires in such a structure the total heat-exchanging area generally increases very considerably. However, the heat exchanger known from the UOP patent has a number of drawbacks. A significant drawback of the known heat exchanger is that heat is transferred in relatively inefficient manner from the first medium to the second medium (and vice versa). Because of the relatively small pore size a substantial part of the second medium will flow along the covering instead of through the covering, which generally reduces heat transfer considerably. Particularly in the case of low flow speeds of the second medium—up to about 20 m/s as is generally the case in motorized vehicles—the efficiency of the heat transfer will be substantially comparable to the efficiency of the heat transfer in conventional fins as discussed in the foregoing.

The invention has for its object to provide an improved heat exchanger for motorized vehicles with which a more efficient cooling of the motor can be realized.

The invention provides for this purpose a heat exchanger of the type stated in the preamble, with the feature that the number of pores per inch (ppi) of the porous structure lies substantially between 20 and 50, and that the thickness of the covering lies between 2 and 8 millimetres. The number of pores per inch lies more preferably between 25 and 30 ppi. The number of pores per inch is reduced considerably compared to the prior art, which results in a better flow through the covering and therefore a more efficient heat transfer between the first medium and the second medium. Since heat exchangers incorporated in motorized vehicles are subjected to freely inflowing gas flows with relatively low flow speeds (up to about 20 metres per second) an optimal boundary layer thickness round the conduit lies between about 0.4 and 0.5 millimetre. If the pore diameter is greater than twice the boundary layer thickness, the interaction between the second medium and the porous structure will then not usually increase further. The pore diameter is therefore preferably limited to 1.0 millimetre, which corresponds to about 25 ppi, and the pore diameter is preferably not made any smaller than 0.8 millimetre, which corresponds to about 30 ppi. In the case the number of pores per inch is less than 20, or at least 25, the heat exchanger can then be compared to a conventional fin structure. Above 50 ppi as in the UOP patent the flow resistance increases such that—as stated—a substantial part of the second medium will flow round the porous structure instead of through the porous structure. By applying a covering with a thickness of between about 2 and 8 millimetres an optimal configuration of the heat exchanger can be obtained, wherein the porous structure is built up of a plurality of stacked pore layers.

The thermally conducting structure is preferably formed by a metal foam. A metal foam has the advantage of being exceptionally heat-conductive, whereby the heat exchange between the first medium and the second medium can be maximized. In a particular preferred embodiment the metal foam is manufactured from at least one of the following metals: copper, nickel and aluminium. In addition, it is possible to envisage manufacturing the metal foam from an alloy. The covering is preferably provided with a corrosion-resistant metal or a metal oxide in order to increase the durability of the heat exchanger by preventing or at least countering degeneration of the heat exchanger.

In a preferred embodiment the wire thickness of the porous structure lies at least substantially between 15 and 90 micrometres, in particular between 20 and 70 micrometres, more in particular between 30 and 60 micrometres. Such a wire thickness can further increase the efficiency of the heat transfer between the first medium and the second medium.

In another preferred embodiment the hydraulic external diameter of the conduit amounts to a maximum of 10 millimetres. Since mention is only made of the hydraulic diameter, the conduit can take very diverse geometric forms. Fin-like conduits or conduits formed in other manner are thus possible in addition to cylindrical conduits, wherein the hydraulic diameter does not exceed the limit of 10 millimetres.

A side of the covering directed toward the conduit preferably makes at least substantially flit thermal contact with the conduit. The heat transfer between the conduit and the porous structure, or between the first medium and the second medium, can thus be optimized.

In a preferred embodiment the covering is connected to the conduit via a thermally conductive means. The thermally conductive means can be very diverse in nature. The thermally conductive means can for instance be formed by a thermally conductive glue, (soldering) paste, thermally conductive metal layer and so on. The thermally conductive means can be arranged in diverse ways, for instance by vapour deposition or by a galvanic deposition process.

In another preferred embodiment the covering is constructed from at least one material strip arranged helically round the conduit. It is thus possible to suffice with use of relatively narrow metal strips which can be arranged round the conduit in relatively simple manner.

The heat exchanger preferably comprises a plurality of mutually coupled conduits in order to increase the overall heat transfer. In a particular preferred embodiment the conduits are positioned at a distance from each other, wherein guide members are arranged between the conduits for guiding the second medium to the covering. The guide member can herein be of very diverse design.

The invention also relates to a motorized vehicle provided with such a heat exchanger.

The invention further relates to a method for applying such a heat exchanger arranged in a motorized vehicle, comprising the steps of: A) carrying a relatively warm first medium through the conduit and B) carrying a relatively cool second medium through the covering in order to cool the first medium. In a preferred embodiment the relatively cool second medium is formed at least substantially by a gas flow, in particular an airflow. In a particular preferred embodiment carrying of the relatively cool gas flow through the covering as according to step B) takes place at a flow speed lying at least substantially between 0 and 20 metres per second.

In addition, the invention relates to a method for manufacturing such a heat exchanger, comprising the steps of: A) arranging a solder on an outer side of the conduit, B) arranging the covering round the conduit while enclosing the solder, C) liquefying the solder, and D) allowing the solder to solidify. The actual adhesion between the conduit and the porous structure takes place during solidifying of the molten solder as according to step D), wherein the contact between the conduit and a side of the porous structure directed toward the conduit can be maximized.

In a preferred embodiment liquefying of the solder as according to step C) takes place by heating the solder. Such a heating can take place indirectly, for instance by applying an electrical voltage preferably immediately and for a very short time, but can also take place directly by increasing the ambient temperature of the solder. It is however also possible to envisage applying other methods for bringing about mutual adhesion of the conduit and the porous structure, such as induction soldering or chemical soldering.

The invention furthermore relates to a method for manufacturing such a heat exchanger, comprising the steps of: A) bringing the conduit into contact with the porous structure, and B) mutually adhering the conduit and the porous structure via an electrical and/or chemical (galvanic) deposition process.

The invention will be elucidated with reference to non-limitative embodiments shown in the following figures. Herein:

FIG. 1 shows schematically a conduit of it beat exchanger according to the invention which is covered with a strip of metal foam,

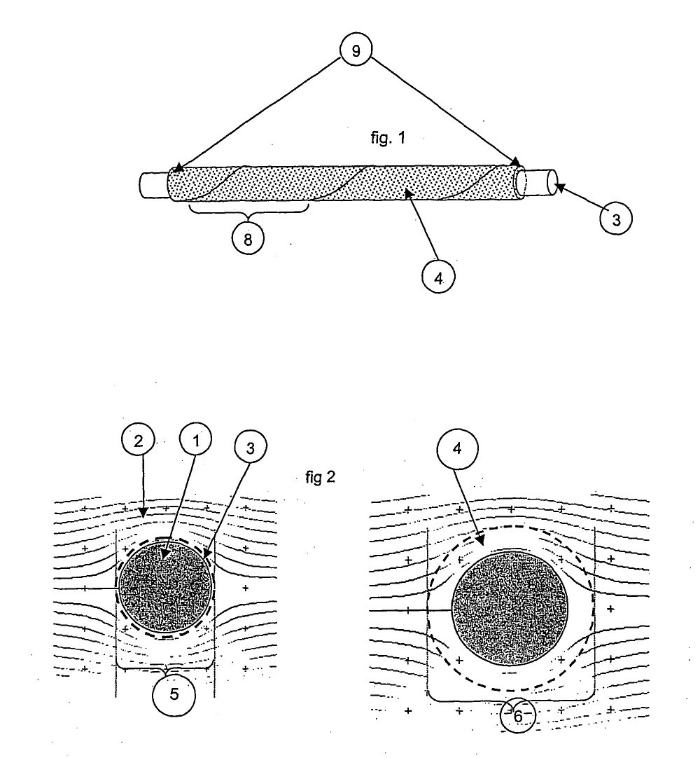

FIGS. 2a and 2b show respectively the boundary layer in the second medium in a conventional heat exchanger and a heat exchanger according to the invention,

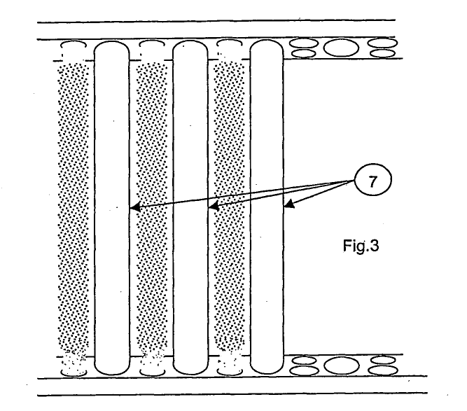

FIG. 3 shows a further development of the heat exchanger according to the invention,

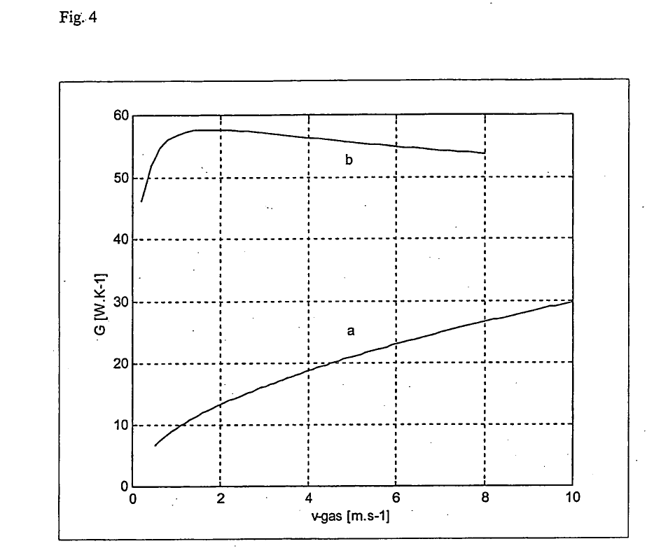

FIG. 4 shows a graphic comparison of the heat transfer between a conventional fin structure and a heat exchanger according to the invention.

FIG. 1 shows as example a part of a conduit 3 through which flows a first medium 1, such as water. Conduit 3, around which flows a second medium 2 such as air, is covered with a thermally conducting three-dimensional structure 4, such as a per se known metal foam. The meta foam here takes the form of a strip 8 which is wrapped helically round the conduit. The connection of the metal foam to the conduit can be effected by means known in this field, such as for instance by means of thermally conductive glue, a thermally conductive paste, a soldering process, or by vapour deposition of an adhesive and heat-conducting metal layer or by a galvanic deposition process. What is important here is that a good thermal contact is created between the three-dimensional structure and the wall of the conduit. A heat-conducting metallic compound is preferably used, preferably on a basis of nickel, copper or aluminium. Depending on the application, a corrosion-resistant metal or metal oxide layer can also be applied to the covering 4. The metal foam consists of heat-conducting material, preferably of nickel, copper or aluminium or alloys thereof. The metal foam can optionally consist of layered combinations of the above mentioned materials. The metal foam has a volume porosity greater than or equal to 90%. The ppi (ores per inch) of the metal foam liea between 20 and 63, and is preferably 35.

FIG. 2a shows the boundary layer in a conventional beat exchanger. The laminar boundary layer is designated schematically here with dashed line 9. This boundary layer has a thickness of 0.1 to 0.4 mm.

In FIG. 2b the virtual boundary layer is shown schematically by dashed line 10, this line 10 practically coinciding with the outer periphery of the three-dimensional structure 4. The thickness of this virtual boundary layer can thus be varied by varying the thickness of the covering. Limiting factor here is the thermal conduction in and through the structure of the covering. With a correct dimensioning of the structure (ppi, type and quantity of metal) an increase in the heat transfer by a factor of 5 to 10 is possible with a laminar flow around the conduits. Because The dimensions of the openings in the three-dimensional structure are of the same order of magnitude as the boundary layer, the space taken up by this structure is utilized optimally for the transfer of heat, whereby the diameter of the covered conduits is smaller than the space which, at the same heat transfer, is occupied with the use of fins. Relative to the conventional heat exchangers a space-saving of 25 to 50% is thus obtained. The table below shows an example of the increase in heat transfer from a single thin-walled aluminium tube (300×7 mm), through which water (F) flows, to an airflow when this tube is covered with a 2 mm-thick layer of copper foam with a volume porosity of 96% and a structure of 35 ppi.

TABLE 1

TABLE 1

| | Measured values | | |
|---|---|---|---|
| | v(air) | F(water) | G tot |
| Type/covering | m.s −1 | 1.min −1 | W.K −1 |
| None | 9.5 | 0.77 | 0.7 |
| Copper foam, 35 | 9.5 | 0.75 | 2.9 |
| PPI, 2 mm thick | 9.5 | 2.15 | 3.2 |

The table shows that, at the same air speed (v), in the case of a tube covered with metal foam according to the invention a substantial improvement results in the heat transfer (G tot) from the first medium (water) to the second medium (air).

FIG. 3 shows a usual construction of a number of parallel conduits 3 which are covered according to the invention and arranged between two manifolds 3a and 3b for the first medium such as water. Since these conduits 3 take up less space, it is efficient to arrange between the conduits 3 guide members 7 which guide the second medium such as air along the porous metallic covering.

FIG. 4 shows a graphic comparison of the heat transfer (G) between a conventional fin structure (line a) and a beat exchanger according to the invention (line b) at different flow speeds of gas (v-gas) as second medium flowing along or through the heat exchangers. The conventional fin structure is constructed from a cylindrical conduit with an external diameter of 7 millimetres and a length of 1 metre. The conduit is herein provided with 870 fins of 18.5×11.5 millimetres in accordance with heat exchangers applied in existing vehicles (in particular of the Volkswagen make). The heat exchanger according to the invention is constructed in this embodiment from the same cylindrical tube with an external diameter of 7 millimetres and a length of 1 metre. Around the tube is arranged a covering of copper foam with a thickness of 5 millimetres and a density of 2 kg/m2. The copper foam herein has a ppi of about 35. The gas flow speed in the shown graph is the flow speed along the fins and through the copper foam and is not the free inflow speed of the gas. The direction of displacement of the gas is herein at least substantially perpendicular to the direction of displacement of a liquid (for cooling) through the conduits. The graphic representation shows clearly that the heat transfer of the heat exchanger according to the invention is significantly higher than the heat transfer of the conventional fin structure. The graphic representation concentrates particularly on relatively low gas flow speeds because of the intended application of the heat exchanger in vehicles. It is particularly at such relatively low gas flow speeds that an engine of a vehicle can be cooled much better and more efficiently by means of the heat exchanger according to the invention than by means of the conventional fin structure. Line b has an optimum at a gas flow speed lying between 1 and 2 m/s, whereby a vehicle traveling very slowly—in contrast to the prior art—can be cooled in relatively efficient manner by means of the heat exchanger according to the invention.

Efficient and simple cooling of an engine of a vehicle travelling very slowly has generally been perceived heretofore as a (great) problem.

It will be apparent that the invention is not limited to the embodiments shown and described here, but that within the scope of the appended claims a large number of variants are possible which will be self-evident for a skilled person in this field.

1-20. (canceled)

21 A heat exchanger for motorized vehicles, comprising:
at least one heat-conducting conduit for passage of a first medium, and a covering of a single thermally conducting porous structure connected to an external side of the conduit for passage of a second medium surrounding the conduit,
wherein the number of pores per inch (ppi) of the porous structure lies substantially between 20 and 50, and that the thickness of the porous structure lies substantially between 2 and 8 millimetres.

22. The heat exchanger as claimed in claim 21, wherein the thermally conducting structure is formed by a metal foam.

23. The heat exchanger as claimed in claim 22, wherein the metal foam is manufactured from at least one of the following metals: copper, nickel and aluminium.

24. The heat exchanger as claimed in claim 21, wherein the covering is provided with a corrosion-resistant metal.

25. The heat exchanger as claimed in claim 21, wherein the wire thickness of the porous structure lies at least substantially between 15 and 90 micrometres.

26. The heat exchanger as claimed in claim 21, wherein the hydraulic diameter of the conduit amounts to a maximum of 10 millimetres.

27. The heat exchanger as claimed in claim 21, wherein a side of the covering directed toward the conduit makes at least substantially full thermal contact with the conduit.

28. The heat exchanger as claimed in claim 21, wherein the covering is connected to the conduit via a thermally conductive means.

29. The heat exchanger as claimed in claim 21, wherein the covering is constructed from at least one material strip arranged helically round the conduit.

30. The heat exchanger as claimed in claim 21, wherein the heat exchanger comprises a plurality of mutually coupled conduits.

31. The heat exchanger as claimed in claim 30, wherein the conduits are positioned at a distance from each other, wherein guide members are arranged between the conduits for guiding the second medium to the covering.

32. A motorized vehicle provided with a heat exchanger as claimed in claim 21.

33. A method for applying a heat exchanger as claimed in claim 21 arranged in a motorized vehicle, comprising the steps of:
A) carrying a relatively warm first medium through the conduit, and
B) carrying a relatively cool second medium through the covering in order to cool the first medium.

34. The method as claimed in claim 33, wherein the relatively cool second medium is formed at least substantially by a gas flow, in particular an airflow.

35. The method as claimed in claim 34, wherein carrying of the relatively cool gas flow through the covering as according to step B) takes place at a flow speed lying at least substantially between 0 and 20 metres per second.

36. A method for manufacturing a heat exchanger as claimed in claim 21, comprising the steps of:
A) arranging a solder on an outer side of the conduit,
B) arranging the covering round the conduit while enclosing the solder,
C) liquefying the solder, and
D) allowing the solder to solidify.

37. The method as claimed in claim 36, wherein liquefying of the solder as according to step C) takes place by heating the solder.

38. The method as claimed in claim 37, wherein the heating of the solder takes place indirectly by applying an electrical voltage.

39. The method as claimed in claim 37, wherein the heating of the solder takes place directly by increasing the ambient temperature of the solder.

40. The method for manufacturing a heat exchanger as claimed in claim 21, comprising the steps of:
A) bringing the conduit into contact with the porous structure, and
B) mutually adhering the conduit and the porous structure via an electrical and/or chemical deposition process.
